(19) United States
(12) Patent Application Publication
(10) Pub. No.: US 2014/0075079 A1
(43) Pub. Date: Mar. 13, 2014

(54) DATA STORAGE DEVICE CONNECTED TO A HOST SYSTEM VIA A PERIPHERAL COMPONENT INTERCONNECT EXPRESS (PCIE) INTERFACE

(71) Applicant: ACCUSYS STORAGE LTD., Hsinchu County (TW)

(72) Inventor: Wen-Sen TSAI, Hsinchu County (TW)

(73) Assignee: ACCUSYS, INC, Hsinchu County (TW)

(21) Appl. No.: 13/760,220

(22) Filed: Feb. 6, 2013

(30) Foreign Application Priority Data
Sep. 10, 2012 (TW) 101133060

(51) Int. Cl. G06F 13/40

(52) U.S. Cl. CPC G06F 13/4027
USPC 710/308

(57) ABSTRACT

An apparatus of a data storage device is provided. The data storage device is connected to a host system via a peripheral component interconnect express (PCIe) interface. The host system includes a first memory having a plurality of first memory space addresses. The data storage device comprises a second memory, a non-transparent bridge (NTB) and a processor. The NTB is coupled to the host system, and having a first portion and a second portion. The processor coupled between the NTB and the second memory, wherein the first portion of the NTB and the plurality of first memory space addresses have a first mapping relationship therebetween, and the processor writes a first datum in the first memory into the second memory via the first mapping relationship according to a command from the host system.

### CROSS-REFERENCE TO RELATED APPLICATION AND CLAIM OF PRIORITY

The application claims the benefit of Taiwan Patent Application No. 101133060, filed on Sep. 10, 2012 in the Taiwan Intellectual Property Office, the disclosures of which are incorporated herein in their entirety by reference.

### FIELD OF THE INVENTION

The present invention relates to a data storage device, and more particularly to a data storage device connected to a host system via a peripheral component interconnect express (PCIe) interface.

### BACKGROUND OF THE INVENTION

The PCIe protocol is a popular type of computer bus protocol, which is applicable to the interconnection inside the computer, the interconnection for a computer with an external device having a chipset (e.g. the display card having a display chip), and the interconnection between the computer and the peripheral for data (e.g. the multimedia data) transmission. Since the PCIe prevails in the information technology industry, many applications of the PCIe interface appear one after another in the technical field of data storage.

Please refer to FIG. 1, which shows a conventional data storage device 110 connected to a host system 101 via a PCIe interface. As shown in FIG. 1, the data storage device 110 includes an input/output (I/O) processor 111, a memory 112 and a redundant array of independent/inexpensive disks (RAID) controller 113. The RAID controller 113 is connected to a plurality of disks 114. The host system 101 has a PCIe terminal 102, and the I/O processor 111 also has a PCIe terminal 102 so that a PCIe interface is formed therebetween.

The conventional I/O processor 111, e.g. the CPU produced by the ARM company, has an efficiency of about 1.2-1.6 G. In nowadays, such a central processing unit (CPU) data transmission efficiency apparently cannot fulfill the requirement for the newly developed information systems. Hence, the famous Intel X86 CPU is used to serve as the I/O processor (e.g. the i5 or i7), since the X86 processor has an efficiency of at least 2-3 G, or is even 4 times the efficiency of the ARM CPU.

Please refer to FIG. 2, which shows a conventional data storage device 210 connected to a host system 101 via a PCIe interface by using an X86 processor 211. As shown in FIG. 2, the data storage device 210 includes a processor 211, a memory 212 and an RAID controller 214. The RAID controller 214 is connected to a plurality of disks 215. Since the processor 211 is an X86 processor, which does not have the PCIe terminal, either fiber channel (FC) or the serial attached small computer standard interface (SAS) has to be used as the communication interface between the processor 211 and the host system 101 to establish the data transmission. The common solution is to dispose an FC/SAS host bus adapter (HBA) 103 for the host system 101, and to dispose an FC/SAS interface IC 213 in the data storage device 210.

In order to achieve the object of using the X86 processor to serve as the I/O processor to enhance the system efficiency, the above-mentioned prior art needs to use the FC/SAS HBA 103 to cooperate with the FC/SAS interface IC 213 disposed in the data storage device 210. However, the cost of such hardware interface is very high.

In order to overcome the drawbacks in the prior art, a data storage device connected to a host system via a peripheral component interconnect express (PCIe) interface is provided. The novel design in the present invention not only solves the problems described above, but also is easy to be implemented. Thus, the present invention has the utility for the industry.

### SUMMARY OF THE INVENTION

In accordance with an aspect of the present invention, by using the non-transparent bridge (NTB), an effective and cheap PCIe communication interface between the I/O processor and the host system is provided.

In accordance with another aspect of the present invention, a data storage device connected to a host system via a peripheral component interconnect, express (PCIe) interface is provided. The host system includes a first memory having a plurality of first memory space addresses. The data storage system includes a second memory; a non-transparent bridge (NTB) coupled to the host system, and having a first portion and a second portion; and a processor coupled between the NTB and the second memory, wherein the first portion of the NTB and the plurality of first memory space addresses have a first mapping relationship therebetween, and the processor writes a first datum in the first memory into the second memory via the first mapping relationship according to a command from the host system.

In accordance with a further aspect of the present invention, a data storage system using an environment having a first memory device is provided. The first memory device has a working address. The data storage system includes a non-transparent bridge (NTB) mapping the working address; and a second memory device obtaining the working address from the NTB, and storing a datum to a working position in the first memory device, wherein the working position corresponds to the working address.

In accordance with further another aspect of the present invention, a data storage method for storing a datum between a host system and a data storage device is provided. The data storage method includes steps of providing a non-transparent bridge (NIB); providing a working address by one of the host system and the data storage device; mapping the working address to the NTB; causing the other of the host system and the data storage device to obtain the working address from the NTB; and sending a command by the other of the host system and the data storage device to store the datum to a working position corresponding to the working address.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a conventional data storage device connected to a host system via a PCIe interface;

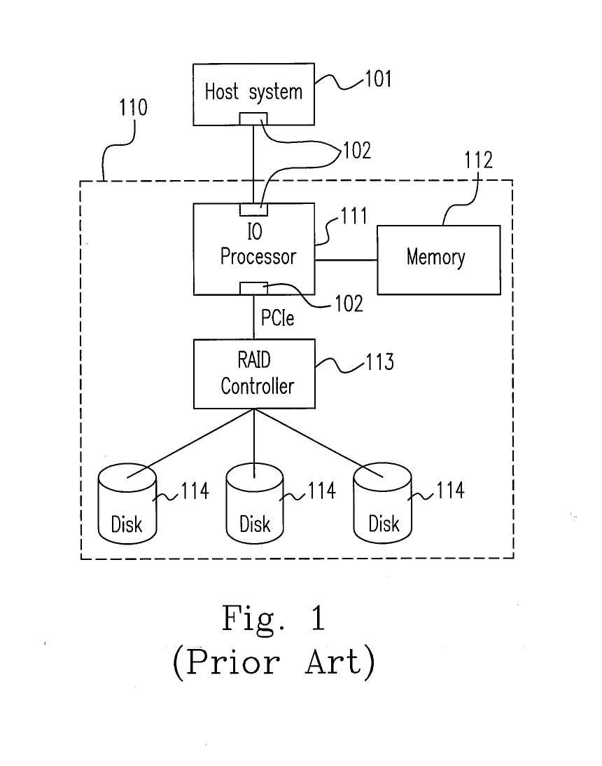

FIG. 2 shows a conventional data storage device connected to a host system via a PCIe interface by using an X86 processor;

FIG. 3 shows a data storage device according to an embodiment of the present invention;

FIG. 4 shows the mapping relationship between the memory space address of the data storage device and the second portion of the NIB as well as that between the memory space address of the host system and the first portion of the NTB;

FIG. 5 shows a flowchart of a method for a data storage device connected to a host system via a PCIe interface according to an embodiment of the present invention; and

FIG. 6 shows a data storage device according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

Non-transparent bridge (NTB) is one of those PCIe elements accustomed to the art. At both sides (or ends) of an NTB, there are processors or intelligent devices, each of which has its own individual memory address space which is invisible to the processor or the intelligent device disposed at the other side. For each processor or intelligent device at one side of the NTB, the other side is considered as a terminal, which maps onto its own address domain. In an NTB environment, a terminal at each side includes two base address registers, or BARs, one for the host device side while the other for the subsidiary device side (for example, a memory or a data storage system). The BAR disposed for supporting the device (either the host system or the subsidiary device) is often named BAR0. The BAR can be utilized as an address translation window for the internal address space at the other side of the NTB, and allows such a translation to be mapped onto an internal or I/O space at its own side.

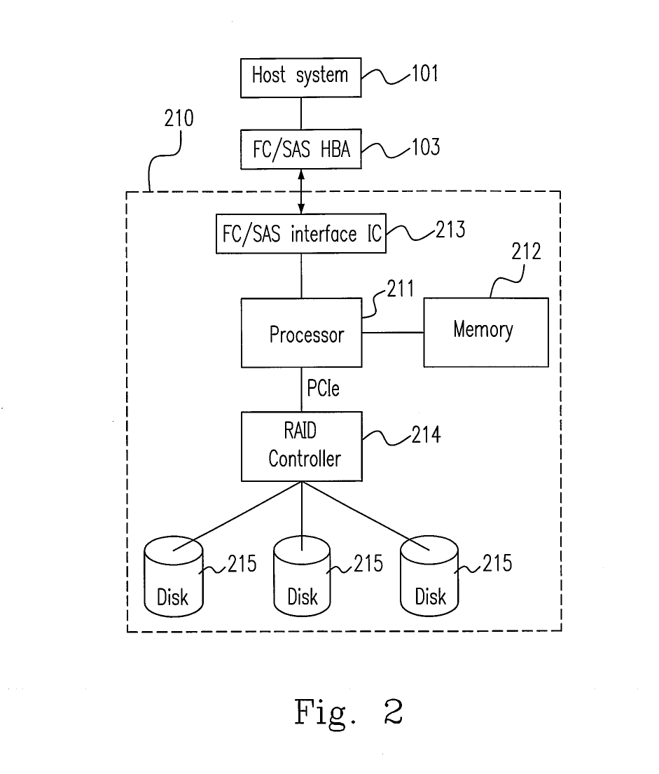

Compared to the prior art as mentioned in the illustrations in FIG. 2, the NTB is a cost-effective as well as efficient solution for providing a PCIe interface between an IO processor and a host system. However, since the completed address or I/O space at one side of an NTB is invisible to the host system or processor disposed at the other side, the host system or processor cannot perform a task of data transportation and data storage all alone. Therefore, one objective of the present invention is to reduce the loading of the processor at the host system by allowing the processor at the data storage device to write the data in the memory of the data storage device into the memory of the host system or vice versa, via the mapping relationship between the BAR0 of the NTB and the memory space address of the host system.

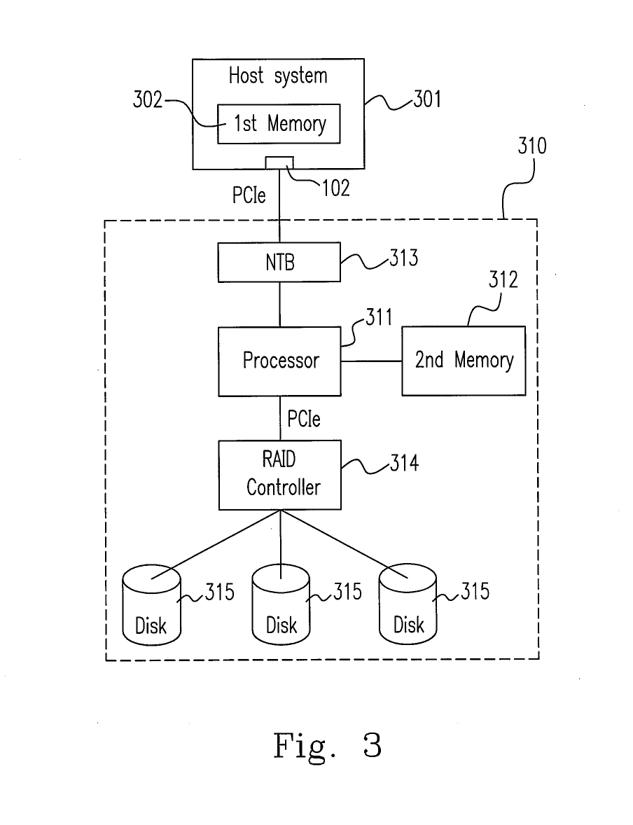

Please refer to FIG. 3, which is a schematic diagram illustrating a data storage device according to one embodiment of the present invention. According to the illustration of FIG. 3, a data storage system 310 is coupled to a host system 301 with a first memory 302 via a PCIe interface. The data storage system 310 includes a processor 311, a second memory 312, an NTB 313 and an RAID controller 314, and is coupled to a plurality of disks 315. The NTB is coupled to a PCIe terminal 102 of the host system 301. In accordance with a preferred embodiment, the processor is an X86 processor coupled between the NTB 313 and the second memory 312. Notably, according to the descriptions set forth above, there is a BAR0 portion at each side of the NTB element, and the BAR0 is only visible to the device (such as the host system 301 or the processor 311) at the same side. An embodiment provided by the present invention is to map the addresses of the memory space of the other side of the NTB onto the BAR0, so as to allow the device at the same side of the BAR0 may visualize the addresses of the memory space of the other side.

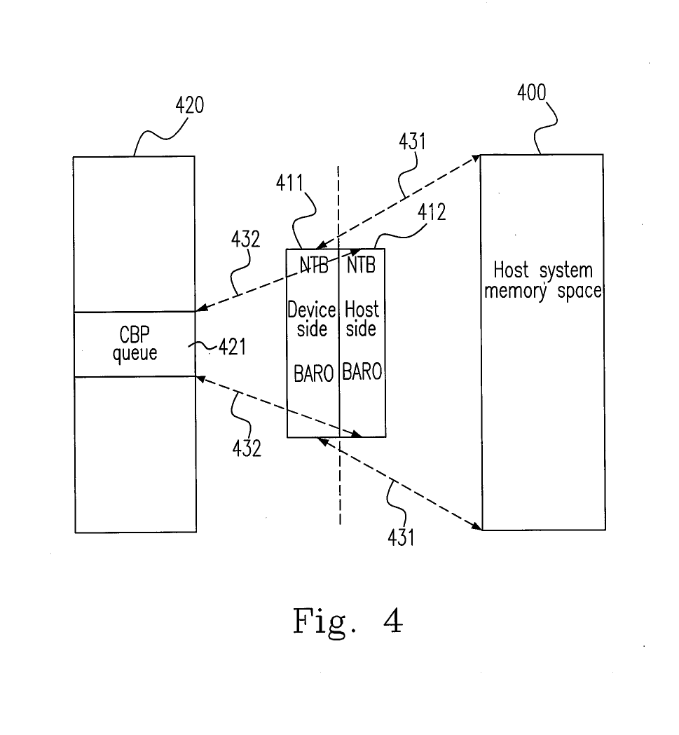

Please refer to FIG. 4, which is a schematic diagram showing the mapping relationship between the memory space addresses and portions of the NTB. In FIG. 4, the NTB includes a BAR0 411 (namely, a first portion) adjacent to the side of the data storage system 310 and a BAR0 412 (namely, a second portion) adjacent to the side of the host system 301. There is a first mapping relationship 431 between the first portion 411 of the NTB 313 and a address space 400 of the host system 301. According to a preferred embodiment of the present invention, the host system 301 maps all the addresses in the storage space 400 into the first portion 411 of the NTB 313 so as to form the first mapping relationship 431 thereinbetween, while the processor 311 does an address space portion 421 in the memory space 420 of the second memory 312 into the second portion of the NTB 313 so as to form a second mapping relationship 432 thereinbetween. The address space portion 421 in the memory space 420 of the second memory 312 is for storing an instruction (not shown), such as a command block register pointer (CBP) queue, which usually does not require a large memory space. On the other hand, during the subsequent data duplication or data storage processes, the processor 311 of the data storage system 310 needs to obtain the mapping addresses for all the memory space 400 of the first memory 302 so as to independently handle the task of data storing.

Upon completion of the establishment of the mapping relationships set forth above, the host system 301 is able to visualize the corresponding addresses of the address space portion 421 via the second mapping relationship 432, and store the instruction into the address space portion 421, while the processor 311 can visualize all the corresponding addresses in the memory space 400 of the first memory 302 via the first mapping relationship 431, and write a datum (not shown) in the first memory 302 into the second memory 312. In accordance with an embodiment of the present invention, the second memory 312 disposed in the data storage system 310 can provides a data buffering function, and the processor 311 performs data storing and writing into the disks 315 afterwards. Otherwise, the processor 311 may read and process another datum (not shown) from the disks 315, and write into the first memory 312 until all the tasks listed in the instruction have been all completed.

In accordance with another aspect of the present invention, a method of data storage can be induced from the embodiments set forth in the preceding descriptions. The method is for storing a datum (not shown) between a working device, such as the host system 301, and a data storage system 310, and includes the following steps: (a) providing a non-transparent bridge (NTB) 313; (b) providing a working address (not shown) by one of the host system 301 and the data storage system 310; (c) mapping the working address to the base address register (BAR0) at the other side of the NTB 313; (d) causing the other of the host system 301 and the data storage system 310 to obtain the working address from the NTB 313; and (e) sending a command by the other of the host system 301 and the storage system 310 to store the datum to a working position corresponding to the working address. Notably, the working position usually locates in the memory device (for example, the first or the second memory 302, 312). The abovementioned method is preferably applied to devices with the PCIe interface.

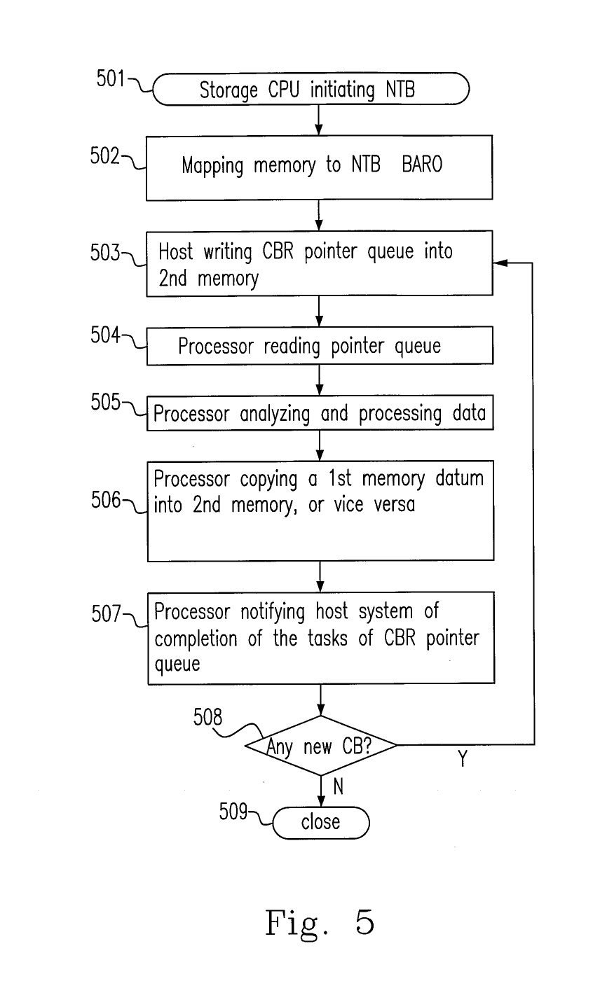

Please refer to FIG. 5, which is a schematic flow diagram showing a method for use by a data storage device connected to a host system via a PCIe interface, as illustrated in FIG. 3, according to an embodiment of the present invention. Firstly, the processor 311 of the data storage system 310 initiates the NTB 313 after the devices are turned on (Step 501). Then, the first mapping relationship 431 between the addresses of the first memory 302 and the BAR0 (the first portion 411) adjacent to the device side and the second mapping relationship 432 between the addresses of the second memory 312 and the BAR0 (the second portion 412) adjacent to the host side are formed separately (Step 502).

After completing the two steps as described in the preceding paragraph, the addresses in the address space portion 421 is visible to the host system 301 via the second mapping relationship 432, so the host system 301 can write an instruction including a command block register (CBR) pointer queue into the second memory 312 (Step 503). The processor 311 may read the instruction from the second memory 312 (Step 504), and performs analyzing and processing to the data according to the instruction (Step 505). According to the instruction provided by the host system 301, the processor 311 can copy a datum (not shown) in the first memory 302 into the second memory 312 or store another datum (not shown) in the second memory 312 into the first memory 302, via the first mapping relationship 431 which renders all the memory space 400 of the first memory 302 visible to the processor 311 (Step 506). According to the abovementioned embodiment of the present invention, the second memory 312 disposed in the data storage system 310 can provide the function of data buffering. The buffered data may be processed by the processor 311 for data storage and written into the disks 315. The processor may also write another datum (not shown) in the second memory 312 into the first memory 302, wherein the datum is previously read and process from the disks 315. The processor 311 continues to perform data processing as per the instruction until all the tasks listed in the queue have been completed, and then the processor 311 sends a message to notify the host system 301 of the completion of all the tasks (Step 507). If there no new instruction, such as a command block (CB), is received (Step 508), the process is corn to an end (Step 509). Otherwise, Steps 503 to 507 are to be repeated once again.

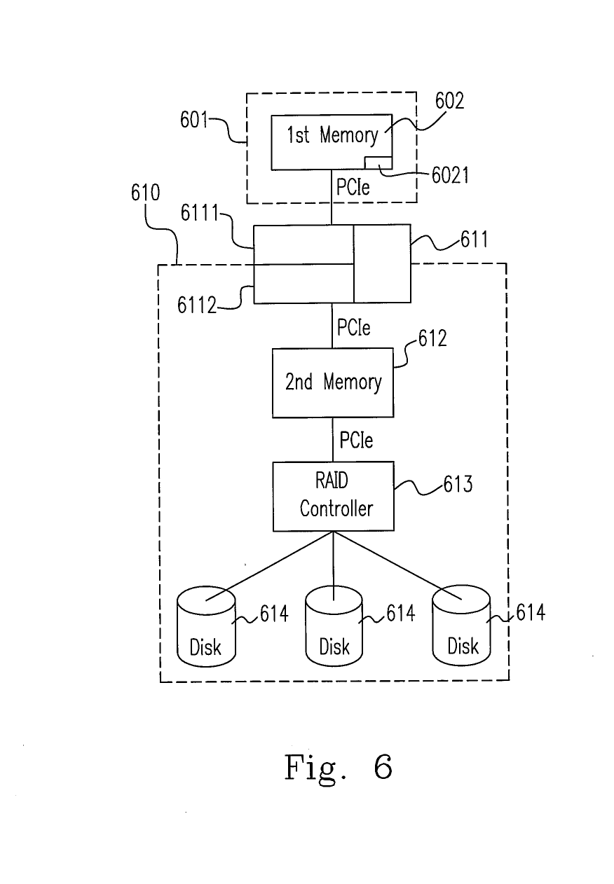

Please refer to FIG. 6, which illustrates a data storage device 610 which is adapted to an environment 601, such as a host system environment, with a first memory device 602, according to another embodiment of the present invention. According to FIG. 6, the data storage system 610 includes an NTB 611, a second memory device 612 and a RAID controller 613 coupled to a plurality of hard disks 614. The NTB 611 comprises a BAR0 6111 disposed at the side adjacent to the first memory device 602 and another BAR0 6112 disposed at the side adjacent to the second memory device 612. The BAR0 6111 maps a working address (not shown) in the first memory device 602 thereon. The second memory device 612 obtains the working address from the BAR0 6111, and stores a datum (not shown) to a working position 6021 in the first memory device 602 corresponding to the working address. Notably, the working position 6021 in the first memory device 602 is a pre-determined memory space address, which is mapped onto the working address of the BAR0 6111. The second memory device 612 can provide the function of data buffering. The data buffered in the second memory device 612 may be further processed for data storage and written into the hard disks 614. The second memory device 612 may also write another datum (not shown) in the second memory device 612 into the first memory 602, wherein the datum is previously read and process from the hard disks 614. According to yet another embodiment of the present invention, the data storage system 610 further includes the first memory device 602.

According to the descriptions set forth above, it is appreciated that, through the concepts of the present invention, the host system is no longer to carry the loadings for data accessing with the data storage system since the processor in the data storage system may take over those tasks. Therefore, the main processor in the host system is able to focus the resources in dealing with other tasks. The high performance processors such as X86 processors can be utilized with the low-cost device allocation of the present invention under the PCIe interface environment, so as to achieve required high data processing efficiencies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

### Embodiments

1. A data storage device connected to a host system via a peripheral component interconnect express (PCIe) interface, wherein the host system includes a first memory having a plurality of first memory space addresses, the data storage device comprising:

a second memory;

a non-transparent bridge (NTB) coupled to the host system, and having a first portion and a second portion; and

a processor coupled between the NTB and the second memory, wherein the first portion of the NTB and the plurality of first memory space addresses have a first mapping relationship therebetween, and the processor writes a first datum in the first memory into the second memory via the first mapping relationship according to a command from the host system.

2. A data storage device of embodiment 1, wherein the processor further writes a second datum in the second memory into the first memory via the first mapping relationship according to the command from the host system.
3. A data storage device of embodiment 1, wherein the processor is an X86 processor.
4. A data storage device of embodiment 1, wherein the second memory has a plurality of second memory space addresses.
5. A data storage device of embodiment 4, wherein the second portion of the NTB and the plurality of second memory space addresses have a second mapping relationship therebetween.
6. A data storage device of embodiment 5, wherein the host system writes the command into the second memory via the second mapping relationship.
7. A data storage device of embodiment 6, wherein the first mapping relationship maps all of the plurality of first memory space addresses to the first portion of the NTB.
8. A data storage device of embodiment 7, wherein the second mapping relationship maps a part of the plurality of second memory space addresses to the second portion of the NTB.
9. A data storage device of embodiment 8, wherein the first portion of the NTB is a first base address register adjacent to the data storage device.
10. A data storage device of embodiment 9, wherein the second portion of the NTB is a second base address register adjacent to the host system.
11. A data storage system using an environment having a first memory device, wherein the first memory device has a working address, the data storage system comprising:

a non-transparent bridge (NTB) mapping the working address; and

a second memory device obtaining the working address from the NTB, and storing a datum to a working position in the first memory device, wherein the working position corresponds to the working address.

12. A data storage system of embodiment 11, further comprising the first memory device.
13. A data storage method for storing a datum between a host system and a data storage device, comprising steps of:

providing a non-transparent bridge (NTB);

providing a working address by one of the host system and the data storage device;

mapping the working address to the NTB;

causing the other of the host system and the data storage device to obtain the working address from the NTB; and

sending a command by the other of the host system and the data storage device to store the datum to a working position corresponding to the working address.

14. A method of embodiment 13, wherein the working address is mapped to a base address register in the NTB.
15. A method of embodiment 14, wherein the base address register is adjacent to the other of the host system and the data storage device failing to provide the working address.
16. A method of embodiment 15, wherein the host system is connected to the data storage device via a peripheral component interconnect express (PCIe) interface.

What is claimed is:

1. A data storage device connected to a host system via a peripheral component interconnect express (PCIe) interface, wherein the host system includes a first memory having a plurality of first memory space addresses, the data storage device comprising:
a second memory;
a non-transparent bridge (NTB) coupled to the host system, and having a first portion and a second portion; and
a processor coupled between the NTB and the second memory, wherein the first portion of the NTB and the plurality of first memory space addresses have a first mapping relationship therebetween, and the processor writes a first datum in the first memory into the second memory via the first mapping relationship according to a command from the host system.

2. A data storage device as claimed in claim 1, wherein the processor further writes a second datum in the second memory into the first memory via the first mapping relationship according to the command from the host system.

3. A data storage device as claimed in claim 1, wherein the processor is an X86 processor.

4. A data storage device as claimed in claim 1, wherein the second memory has a plurality of second memory space addresses.

5. A data storage device as claimed in claim 4, wherein the second portion of the NTB and the plurality of second memory space addresses have a second mapping relationship therebetween.

6. A data storage device as claimed in claim 5, wherein the host system writes the command into the second memory via the second mapping relationship.

7. A data storage device as claimed in claim 6, wherein the first mapping relationship maps all of the plurality of first memory space addresses to the first portion of the NTB.

8. A data storage device as claimed in claim 7, wherein the second mapping relationship maps a part of the plurality of second memory space addresses to the second portion of the NTB.

9. A data storage device as claimed in claim 8, wherein the first portion of the NTB is a first base address register adjacent to the data storage device.

10. A data storage device as claimed in claim 9, wherein the second portion of the NTB is a second base address register adjacent to the host system.

11. A data storage system using an environment having a first memory device, wherein the first memory device has a working address, the data storage system comprising:
a non-transparent bridge (NTB) mapping the working address; and
a second memory device obtaining the working address from the NTB, and storing a datum to a working position in the first memory device, wherein the working position corresponds to the working address.

12. A data storage system as claimed in claim 11, further comprising the first memory device.

13. A data storage method for storing a datum between a host system and a data storage device, comprising steps of:
providing a non-transparent bridge (NTB),
providing a working address by one of the host system and the data storage device;
mapping the working address to the NTB;
causing the other of the host system and the data storage device to obtain the working address from the NTB; and
sending a command by the other of the host system and the data storage device to store the datum to a working position corresponding to the working address.

14. A method as claimed in claim 13, wherein the working address is mapped to a base address register in the NTB.

15. A method as claimed in claim 14, wherein the base address register is adjacent to the other of the host system and the data storage device failing to provide the working address.

16. A method as claimed in claim 15, wherein the host system is connected to the data storage device via a peripheral component interconnect express (PCIe) interface.
